(19) United States
(12) Patent Application Publication
(10) Pub. No.: US 2019/0047026 A1
(43) Pub. Date: Feb. 14, 2019

(54) ASSEMBLY OF A BUOYANCY MODULE AND AN ANTI-FOULING SYSTEM

(71) Applicant: KONINKLIJKE PHILIPS N.V., EINDHOVEN (NL)

(72) Inventors: Martinus Hermanus Wilhelmus Maria VAN DELDEN, Venlo (NL); Bart Andre SALTERS, Eindhoven (NL); Hugo Johan CORNELISSEN, Escharen (NL); Roelant Boudewijn HIETBRINK, Utrecht (NL)

(21) Appl. No.: 16/076,944

(22) PCT Filed: Feb. 1, 2017
(86) PCT No.: PCT/EP2017/052171

§ 371 Date: Aug. 9, 2018

(30) Foreign Application Priority Data
Feb. 15, 2016 (EP) 16155690.7

(51) Int. Cl. B08B 7/00; B08B 9/023; B63C 11/52

(52) U.S. Cl. CPC B08B 7/0057; B08B 17/00; B63C 11/52; B08B 9/023

(57) ABSTRACT

In an assembly of a buoyancy module (10) and an anti-fouling system, the buoyancy module (10) is adapted to floatingly support a functional device (40) in an underwater environment. In particular, the anti-fouling system comprises at least one anti-fouling appliance (23, 24) for performing an anti-fouling action on at least a portion of the exterior surface (16) of the buoyancy module (10), wherein the anti-fouling appliance (23, 24) has an exterior arrangement with respect to the buoyancy module (10) while being mechanically coupled to the buoyancy module (10) and/or being adapted for mechanical coupling to a functional device (40), and/or is arranged on the exterior surface (16) of the buoyancy module (10), and/or is arranged in the interior of the buoyancy module (10). In a practical embodiment, the anti-fouling appliance comprises an ultraviolet light source (23) and possibly also a light guide (24) coupled to the ultraviolet light source (23).

### FIELD OF THE INVENTION

The invention relates to an assembly of a buoyancy module and an anti-fouling system, the buoyancy module being adapted to floatingly support a functional device in an underwater environment.

In the second place, the invention relates to an anti-fouling system intended for use in such assembly, and also to a buoyancy module intended for use in such assembly.

In the third place, the invention relates to an assembly of a functional device and at least one buoyancy module as mentioned, the at least one buoyancy module being arranged on the functional device, and the functional device optionally being a marine riser module, and also to a marine system, comprising a marine device for retrieving matter from the (sub) sea bed and at least one such assembly, the marine device being in communication with the (sub) sea bed through the functional device of the assembly.

### BACKGROUND OF THE INVENTION

In the field of offshore industry, the use of buoyancy modules is widespread and is aimed at ensuring that a device such as a riser is held in a wave configuration when submerged. A riser is a flexible pipeline which serves for interconnecting a well of oil or gas at the (sub) sea bed to a surface vessel floating on the sea, so that crude oil or gas can be pumped from the lowest level where it is extracted from the (sub) sea bed to the highest level where it is received in the surface vessel. Hence, riser lengths may range from several hundreds of meters to several thousands of meters. As a consequence of these lengths, precautions must be taken to prevent a riser from snapping or breaking under its own weight and/or due to being crushed at large depth and/or withstanding forces caused by waves and tides. In addition, when the riser is used for pumping oil, internal pressures in the riser can get as high as 300 bar. For this reason, risers are normally reinforced by a steel core acting as a tension wire, enclosed by one or more outer mantles made of plastic or steel, finished with a thick rigid and insulating polymer coating serving as protection against the elements. Thus, deep sea risers can be extremely heavy.

A riser is installed in the sea by means of a surface vessel carrying the riser on a roll which is to be unwound in the installation process in order to submerge the riser in the water in a gradual fashion. In order to prevent an unrolled/unrolling riser from extreme bending, and also from collapsing or tipping over the surface vessel and/or dragging the vessel down to the depths, it is important to control the riser's shape and effective weight. This is where the buoyancy modules come in. In fact, buoyance modules are large floaters which are designed to support risers, cables etc. in an underwater environment. Normally, one riser is provided with a plurality of buoyancy modules, wherein the buoyancy modules are more or less equally distributed over at least a portion of the length of the riser. According to a usual design, a buoyancy module is generally cylinder shaped, comprising two halves which are hingedly connected to each other so as to allow for an opened condition of the buoyancy module, in which the buoyancy module is suitable for receiving a portion of a riser, and a closed condition of the buoyancy module, in which the buoyancy module encloses the portion of the riser extending through the buoyancy module at a central position in the buoyancy module. A buoyancy module may typically measure up to 2 meters in diameter and 1.5 to 3 meters in length/height. Fixation of a buoyancy module on a riser is realized by means of straps and/or clamps, which are put to a closed position before the buoyancy module and the portion of the riser enclosed by the buoyancy module is submerged from the surface vessel.

The buoyancy modules are fixed to a riser at predetermined positions, wherein the positions are accurately chosen so as to be capable to exactly realize a wave configuration of the riser as desired. In particular, at the predetermined positions, the distributed buoyancy modules serve as submerged yet neutral buoyant platforms or anchoring points at given depths, so that the shape of the riser can be guided into that of a natural arch between the submerged suspension point and the sea bed as well as between the submerged suspension point and the surface vessel. In that way, mechanical stresses onto the riser down into the depths are minimized and under control, whereas the surface motion of the surface vessel due to tidal waves and weather influences as well as controlled vessel displacement is allowed within certain limitations.

It follows from the foregoing that it is of extreme importance that the submerged suspension points are stable in position and depth. In order to sustain control of the position and the depth of the buoyancy modules, drag due to currents and displacements of seawater due to factors like salinity and temperature gradients should remain under control, and the same is applicable to the buoyancy of the buoyancy modules. However, the fact is that in practice, it is very difficult if not impossible to maintain the drag and the buoyancy of the distributed buoyancy modules at a desired, initial level. The reason is found in a phenomenon known as biological fouling or biofouling.

In general, biofouling is the accumulation of microorganisms, plants, algae, small animals and the like on surfaces. According to some estimates, over 1,800 species comprising over 4,000 organisms are responsible for biofouling. Hence, biofouling is caused by a wide variety of organisms, and involves much more than an attachment of barnacles and seaweeds to surfaces. Biofouling is divided into micro fouling which includes biofilm formation and bacterial adhesion, and macro fouling which includes the attachment of larger organisms. Due to the distinct chemistry and biology that determine what prevents them from settling, organisms are also classified as being hard or soft. Hard fouling organisms include calcareous organisms such as barnacles, encrusting bryozoans, mollusks, polychaetes and other tube worms, and zebra mussels. Soft fouling organisms include non-calcareous organisms such as seaweed, hydroids, algae and biofilm “slime”. Together, these organisms form a fouling community.

In several situations, biofouling creates substantial problems. Biofouling can cause machinery to stop working, water inlets to get clogged, and heat exchangers to suffer from reduced performance. Hence, the topic of anti-fouling, i.e. the process of removing or preventing biofouling, is well-known. In industrial processes involving wetted surfaces, bio dispersants can be used to control biofouling. In less controlled environments, fouling organisms are killed or repelled with coatings using biocides, thermal treatments or pulses of energy. Nontoxic mechanical strategies that prevent organisms from attaching to a surface include choosing a material or coating for causing the surface to be slippery, or creating nanoscale surface topologies similar to the skin of sharks and dolphins which only offer poor anchor points.

Biofouling of buoyancy modules causes severe problems. Over time, it may happen that the drag of the buoyancy modules increases while the buoyancy of the buoyancy modules decreases, as a result of which more and more mechanical stresses are exerted on both the riser and relevant components of the surface vessel, especially during bad weather. In view of the fact that the normal lifetime of the riser and the associated buoyancy modules is something like 25 years, maintenance is necessary in order to avoid a situation in which it is no longer possible to control the riser and the associated buoyancy modules, i.e. a dangerous situation in which the riser might break and/or the surface vessel might collapse or even sink. Mechanical cleaning of buoyancy modules is difficult to realize in practice due to their relatively large diameter and their operating depth, which may be well beyond the reach of normal diving activities, i.e. lower than about 100 meters under the water surface. Hence, there is a need for a durable solution aimed at keeping a submerged buoyancy module clean.

Traditionally, there are two recognized approaches to anti-fouling which are relevant to the low current velocity environment of a steel catenary riser: 1) providing a toxic surface onto which biofouling species cannot attach and survive, and 2) applying slow release coatings. The first approach involves a release of toxic species into the marine environment, which may be prohibited in the future for obvious reasons. The second approach involves a process in which a binder resin slowly dissolves or hydrolyses such as to release a biocidally-active chemical into the immediate near-surface environment, and is expected to be prohibited and abandoned any time soon. Due to the nature of the two approaches and the harm that the bio toxic and biocidally-active materials associated therewith cause also after their release into the seawater, not only to biofouling organisms but also to other forms of marine life, there is a need for another more environmentally friendly and green alternative for keeping submerged buoyancy modules clean from biofouling.

### SUMMARY OF THE INVENTION

It is an object of the invention to provide measures for at least slowing down if not preventing biofouling of submerged buoyancy modules. In view thereof, according to the invention, an assembly of a buoyancy module and an anti-fouling system is provided, the buoyancy module being adapted to floatingly support a functional device in an underwater environment, and the anti-fouling system comprising at least one anti-fouling appliance for performing an anti-fouling action on at least a portion of the exterior surface of the buoyancy module, wherein the anti-fouling appliance has an exterior arrangement with respect to the buoyancy module, in which at least a portion of the anti-fouling appliance is supported on the buoyancy module and/or is adapted to be supported on a functional device, and/or is arranged on the exterior surface of the buoyancy module, and/or is arranged in the interior of the buoyancy module.

In an assembly according to the invention, use is made of an anti-fouling appliance for acting on at least a portion of the exterior surface of the buoyancy module in order to keep at least a portion of the surface free from biofouling. For the sake of completeness, it is noted that in the usual design of the buoyancy module as explained in the foregoing, the exterior surface includes both the exterior surface of the general outline of the buoyancy module and the exterior surface of a central portion of the buoyancy module for actually surrounding a riser, cable or other device to be floatingly supported by the buoyancy module. Basically, the exterior surface of the buoyancy module is the surface of the buoyancy module which is exposed to a fluid which may have a bio-fouling effect on the surface, at least during a part of the lifetime of the buoyancy module.

Preferably, the anti-fouling appliance is adapted to act on the exterior surface of the buoyancy module in such a way that initial deposition of a microbial biofilm which facilities subsequent settlement and attachment of macro fouling organisms is prevented. According to the invention, the anti-fouling appliance may act on the surface in any possible way, in particular directly, indirectly, from a position on the surface or close to the surface, from a position remote from the surface, whatever is useful in a given situation. To that end, the anti-fouling appliance may have any suitable position with respect to the surface, and may be arranged in the interior of the buoyancy module, may be arranged on the surface, and/or may have an exterior arrangement with respect to the buoyancy module while being at least partially supported on the buoyancy module and/or being adapted to be at least partially supported on a functional device.

In an advantageous embodiment of the assembly of a buoyancy module and an anti-fouling system according to the invention, the anti-fouling appliance is adapted to emit anti-fouling energy during operation thereof. It is practical for the anti-fouling appliance to be particularly adapted to emit ultraviolet light during operation thereof. A general advantage of using ultraviolet light for realizing anti-fouling is that the microorganisms are prevented from adhering and rooting on the surface to be kept clean, without any harmful side effects or side effects which cannot be easily counteracted.

For the sake of completeness, the following is noted in respect of anti-fouling by using ultraviolet light. The anti-fouling appliance may be chosen to specifically emit ultraviolet light of the c type, which is also known as UVC light, and even more specifically, light with a wavelength roughly between 250 nm and 300 nm. It has been found that most fouling organisms are killed, rendered inactive, or rendered unable to reproduce by exposing them to a certain dose of the ultraviolet light. A typical intensity which appears to be suitable for realizing anti-fouling is 10 mW per square meter, to be applied continuously or at a suitable frequency. A very efficient source for producing UVC light is a low pressure mercury discharge lamp, in which an average of 35% of input power is converted to UVC power. Another useful type of lamp is a medium pressure mercury discharge lamp. The lamp may be equipped with an envelope of special glass for filtering out ozone-forming radiation. Furthermore, a dimmer may be used with the lamp if so desired. Other types of useful UVC lamps are dielectric barrier discharge lamps, which are known for providing very powerful ultraviolet light at various wavelengths and at high electrical-to-optical power efficiencies, lasers and LEDs. In respect of the LEDs, it is noted that they can generally be included in relatively small packages and consume less power than other types of light sources. LEDs can be manufactured to emit (ultraviolet) light of various desired wavelengths, and their operating parameters, most notably the output power, can be controlled to a high degree.

An anti-fouling appliance for emitting ultraviolet light can be provided in the form of a tubular lamp, more or less comparable to a well-known TL (tube luminescent/fluorescent) lamp. For various known germicidal tubular UVC lamps, the electrical and mechanical properties are comparable to those properties of tubular lamps for producing visible light. This allows the UVC lamps to be operated in the same way as the well-known lamps, wherein an electronic or magnetic ballast/starter circuit may be used, for example.

According to a first possibility existing within the framework of the invention, the anti-fouling appliance is adapted to emit anti-fouling energy during operation thereof, and is at least partially arranged in the interior of the buoyancy module, wherein the anti-fouling system comprises at least one portion of the buoyancy module which is transparent to the anti-fouling energy and includes at least a portion of the exterior surface of the buoyancy module. In the usual design of the buoyancy module, it is advantageous if both halves are equipped with at least one anti-fouling appliance, which does not alter the fact that it may suffice to have at least one anti-fouling appliance in only one of the halves in case of an optical coupling being provided between the halves. Furthermore, it is advantageous if the at least one anti-fouling appliance is allowed to illuminate the entire exterior surface of a half of the buoyancy module from the interior of the buoyancy module. In a practical embodiment, the portion of the buoyancy module which is transparent to the anti-fouling energy comprises an exterior layer of the buoyancy module. In conformity with the remark relating to the fact that the term “exterior surface” should be understood to cover both the exterior surface of the general outline of the buoyancy module and the exterior surface of a central portion of the buoyancy module for actually surrounding a device to be floatingly supported by the buoyancy module, it is noted that the term “exterior layer” may be applied to a layer as present on at least a portion of one or both of the first exterior surface and the latter exterior surface. Having an exterior layer as mentioned involves the advantage of not needing to have large transparent portions in the buoyancy module, so that the effect of putting the measures according to the invention to practice on factors like manufacturing costs and mechanical strength of the buoyancy module can be kept to a minimum.

When an exterior layer is applied, it may be so that the anti-fouling system comprises a plurality of anti-fouling energy sources for emitting anti-fouling energy during operation thereof, the energy sources being arranged in a grid or mesh which is incorporated in the layer. In that case, it is practical for the energy sources to be LEDs for emitting ultraviolet light. It is also possible for the exterior layer to include only a minimum of energy sources and to be designed in such a way as to be suitable for serving as a light guide with predefined positions for allowing the light to shine outwardly from the layer.

According to a second possibility existing within the framework of the invention, the anti-fouling appliance comprises at least one anti-fouling energy source for arrangement at an exterior position with respect to the buoyancy module and an energy guide for receiving anti-fouling energy from the energy source during operation thereof and guiding the anti-fouling energy towards the exterior surface of the buoyancy module. For example, the anti-fouling energy source may be arranged at a remote location, such as at a surface vessel. When the anti-fouling energy source is a light source for emitting ultraviolet light, the energy guide may be any suitable light guide such as an optical fiber or light hose. It may be so that the energy guide is suitable for arrangement completely outside of the buoyancy module, but that does not alter the fact that it is also possible to use an energy guide of which at least a portion is suitable for arrangement in the interior of the buoyancy module, in which case it is practical for the anti-fouling system to furthermore comprise at least one portion of the buoyancy module which is transparent to the anti-fouling energy emitted by the energy source during operation thereof and transported to the buoyancy module by the energy guide, the portion of the buoyancy module including at least a portion of the exterior surface of the buoyancy module, in a similar manner as is the case with a possible application of at least one anti-fouling energy source in the interior of the buoyancy module.

When the energy guide is suitable for arrangement at an exterior position with respect to the buoyancy module, it is possible for the energy guide to have an elongated appearance and to be designed for arrangement with respect to the buoyancy module in a spiral-like fashion, such that the energy guide is made to contact the exterior surface of the buoyancy module or to extend at a certain distance from the exterior surface of the buoyancy module, whatever the case may be, wherein the energy guide may be positioned so as to encompass the buoyancy module at the outline thereof and/or so as to be present in an inner space of the buoyancy module for receiving the functional device to be floatingly supported by the buoyancy module. Alternatively, it is possible for the anti-fouling system to comprise a sleeve-like structure for encompassing the buoyancy module and/or a sleeve-like structure for extending at a central position through the buoyancy module, the energy guide being incorporated in the structure. In respect of the sleeve-like structure, it is also true that this structure may be adapted to contact the exterior surface of the buoyancy module or to extend at a certain distance from the exterior surface of the buoyancy module. In the case of a certain distance being present, suitable spacers may be used.

In general, both structures in which the at least one anti-fouling appliance is allowed to act directly on at least a portion of a surface to be kept clean and structures in which the at least one anti-fouling appliance is allowed to act indirectly on at least a portion of a surface to be kept clean are possible within the scope of the invention, wherein the at least one anti-fouling appliance may be arranged in the interior of the buoyancy module, on the exterior surface of the buoyancy module, and/or at an exterior position with respect to the buoyancy module. In the case of indirect action of the anti-fouling appliance, assuming that the anti-fouling appliance is adapted to emit anti-fouling energy during operation thereof, it is practical for the anti-fouling system to comprise reflecting means, i.e. one or more reflectors, for directing the energy towards at least a portion of the exterior surface of the buoyancy module. Using one or more reflectors may add to freedom of design of the anti-fouling system, realizing more possibilities for determining an appropriate positioning of the at least one anti-fouling appliance. Also, using one or more reflectors involves the advantageous possibility of spreading the energy across a surface area which is larger than the surface area which would be covered in a situation of the anti-fouling appliance acting directly on the surface.

When at least one anti-fouling appliance having an exterior arrangement with respect to the buoyancy module is used in the anti-fouling system, the overall efficiency of the system is related to the transparency of the seawater to the energy emitted by the anti-fouling appliance during operation thereof. When at least one anti-fouling appliance which is arranged in the interior of the buoyancy module is used in the anti-fouling system, the material of the portion(s) of the buoyancy module through which the energy travels may be chosen so as to have a good transparency, i.e. a transparency which is at least higher than the transparency of the seawater, so that the overall efficiency of the system may be increased.

In respect of the possibility of having at least one anti-fouling appliance arranged at an exterior position with respect to the buoyancy module, it is noted that the anti-fouling system may comprise an arrangement for holding the anti-fouling appliance at a position which is a position at a distance from the buoyancy module, and which is a position for allowing the energy to reach the exterior surface of the buoyancy module, directly and/or indirectly, whatever may be appropriate in a particular case. When the anti-fouling appliance is adapted to emit ultraviolet light during operation thereof, a remote configuration may comprise flood or spot light sources, illuminating the exterior surface of the buoyancy module from an add-on of the buoyancy module, for example. The anti-fouling appliance may even comprise a laser light source, wherein the laser light source may be arranged such as to scan the surface.

An add-on of the buoyancy module for carrying at least one energy source and/or at least one energy guide may come in the form of spiral bars, rings of any suitable shape, ribs or diameter clamping or enclosing structures. Other examples of an add-on include meshes, bandages and nettings, which may be put in place on the buoyancy module by means of straps or other suitable means. An add-on may comprise a sleeve-like structure for extending around or through the buoyancy module, in which case a zip may be provided for closing the structure, for example. A general advantage of applying an add-on in the anti-fouling system is that the add-on may come as a consumable or serviceable part that can be deployed or removed as desired. Also, there is no need for changing the overall design of the buoyancy module, and a single type of add-on may be of such design that it is suitable to be used with various types of buoyancy module. Advantageously, an arrangement for holding the at least one energy source and/or the at least one energy guide is adapted to provide mechanical protection of the energy source(s) and/or the energy guide(s).

In the case that the anti-fouling system comprises at least one energy source for emitting anti-fouling energy during operation thereof, the at least one energy source may particularly have an elongated shape, and may be designed for arrangement with respect to the buoyancy module in a spiral-like fashion. Likewise, it is possible for the anti-fouling system to comprise a plurality of energy sources for emitting anti-fouling energy during operation thereof, and a structure having an elongated shape, which is designed for arrangement with respect to the buoyancy module in a spiral-like fashion, the energy sources being incorporated in the structure. The design of such structure may be so as to add a protecting functionality to the carrying functionality thereof. Alternatively, in the case that the anti-fouling system comprises a plurality of energy sources for emitting anti-fouling energy during operation thereof, the anti-fouling system may be equipped with a sleeve-like structure for extending around or through the buoyancy module, the structure comprising at least one ring, for example, a circular ring or an oval ring, and the energy sources being incorporated in the at least one ring.

In an embodiment of the anti-fouling system which is particularly intended for use with a buoyancy module comprising outwardly extending drag reducing baffles, and which comprises anti-fouling energy sources for emitting anti-fouling energy during operation thereof, the energy sources are designed for arrangement on the baffles. An advantage of this embodiment is that the baffles may be used for realizing mechanical protection of the energy sources. In this respect, it is noted that the energy sources may be provided as an integral part of the baffles. Moreover, the baffles could be equipped with a long lasting power source for powering the energy sources, or a device for generating power. The same is applicable to the body of the buoyancy module.

In general, when the anti-fouling system includes a mesh, a bandage, a netting or the like for supporting at least one energy source and/or at least one energy guide, spacers may be used for keeping the at least one energy source and/or at least one energy guide at a suitable distance with respect to the exterior surface of the buoyancy module. When the buoyancy module is equipped with drag reducing baffles as mentioned in the foregoing, the baffles may be used as such spacers.

It follows from the foregoing that the invention relates to an assembly of a buoyancy module and an anti-fouling system which is adapted to be operated to perform an anti-fouling action on at least a portion of the exterior surface of the buoyancy module. Hence, by applying the invention, problems associated with a fouled condition of the exterior surface of a buoyancy module are alleviated. The buoyancy of the buoyancy module stays at the level envisaged in the designing phase of the buoyancy module, and the drag of the buoyancy module remains at a minimum level as desired. The invention also relates to an anti-fouling system comprising at least one anti-fouling appliance for performing an anti-fouling action on at least a portion of the exterior surface of a buoyancy module, intended for use in the assembly as mentioned. Furthermore, the invention relates to a buoyancy module for mounting on a functional device for floatingly supporting the functional device in an underwater environment, intended for use in the assembly as mentioned, and also to an assembly of a functional device and at least one such buoyancy module arranged on the functional device, wherein the functional device may be a marine riser module or another module to be provided with one or more buoyancy modules for support in a fluid such as water.

In respect of the assembly of a functional device and at least one buoyancy module arranged on the functional device, it is noted that such assembly may be part of a marine system which furthermore comprises a marine device for retrieving matter such as oil from the sea bed, the marine device being in communication with the sea bed through the functional device of the assembly. In particular, in the context such marine system, the functional device may have a function in connecting the marine device to a stationary marine object at the level of the sea bed, such as a subsea oil well. By significantly decreasing the extent to which the at least one buoyancy module suffers from biofouling, it is achieved that less stress occurs in mechanical coupling structures in the marine system, which is beneficial to the lifetime of the coupling structures, wherein damage to the coupling structures may be avoided.

The above-described and other aspects of the invention will be apparent from and elucidated with reference to the following detailed description of a number of embodiments of an anti-fouling system as used with a buoyancy module, particularly an anti-fouling system comprising one or more sources for emitting ultraviolet light.

### BRIEF DESCRIPTION OF THE DRAWINGS

The invention will now be explained in greater detail with reference to the figures, in which equal or similar parts are indicated by the same reference signs, and in which:

FIG. 1 illustrates a general design of a buoyancy module;

FIG. 2 diagrammatically shows a buoyancy module which is equipped with a tubular ultraviolet lamp arranged in the interior of the buoyancy module;

FIG. 3 diagrammatically shows a buoyancy module which is equipped with an exterior layer of distributed ultraviolet LEDs;

FIG. 4 diagrammatically shows a buoyancy module which is equipped with an elongated light guide coupled to an ultraviolet laser source, the light guide having a coiled appearance and being wrapped around the buoyancy module;

FIG. 5 diagrammatically shows an I bar for use with a buoyancy module, the I bar accommodating ultraviolet light sources and reflectors;

FIGS. 6 and 7 illustrate an alternative embodiment of the I bar shown in FIG. 5;

FIG. 8 diagrammatically shows a buoyancy module which is equipped with a structure comprising rings encompassing the buoyancy module, the rings accommodating ultraviolet light sources; and

FIG. 9 diagrammatically shows a buoyancy module comprising drag reducing baffles and light sources arranged on the baffles.

### DETAILED DESCRIPTION OF EMBODIMENTS

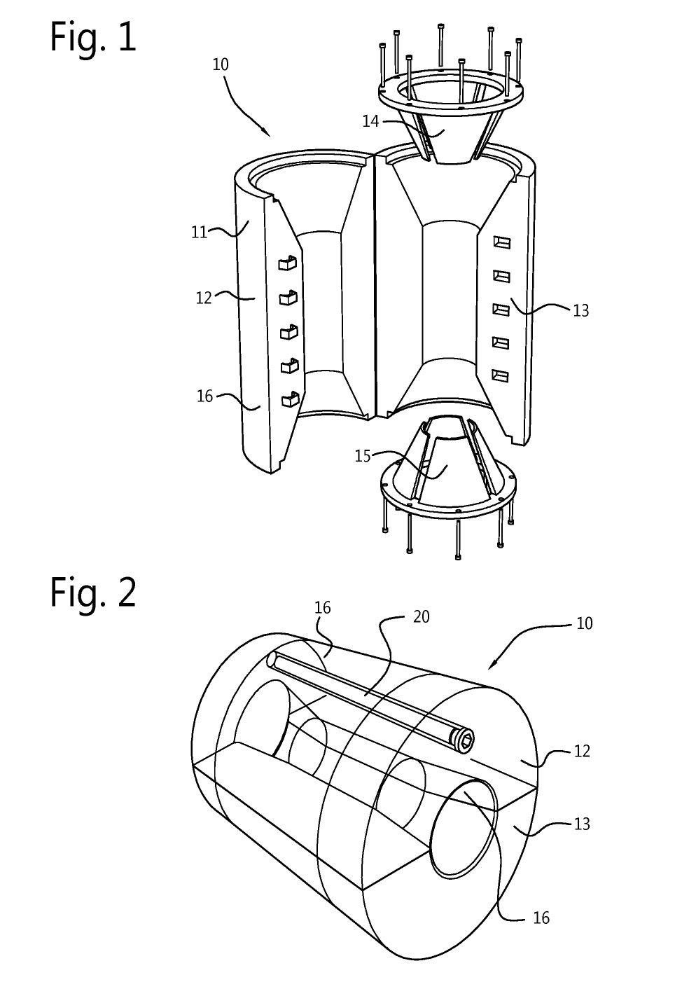

The invention is in the field of buoyancy modules, which are normally used in a marine environment for suspending elongated devices such as cables and pipes extending from a surface vessel or surface structure to the bottom of the sea, and which are designed to act as floats in the water, wherein the elongated device is normally provided with a plurality of buoyancy modules distributed along the length thereof. FIG. 1 illustrates a general design of a buoyancy module. According to this design, the buoyancy module 10 is generally cylinder shaped and comprises a main body 11 having two halves 12, 13 which are hingedly connected to each other so as to allow for an opened condition of the main body 11 as shown in FIG. 1, in which the main body 11 is suitable for receiving a portion of an elongated device (not shown), and a closed condition of the main body 11, in which the main body 11 encloses the portion of the elongated device extending through the main body 11 at a central position in the main body 11. Fixation of the buoyancy module 10 on the elongated device is realized in any suitable manner. In the shown example, the buoyancy module 10 further comprises two end pieces 14, 15 having a ring-shaped portion for encompassing the elongated device at end positions of the main body 11. In this design, arranging the buoyancy module 10 on an elongated device comprises the steps of 1) arranging the end pieces 14, 15 on the elongated device and positioning the main body 11 of the buoyancy module 10 with respect to the elongated device in the opened condition so as to be able to receive a portion of the elongated device, and 2) putting the main body 11 to the closed condition and putting the end pieces 14, 15 in place on the main body 11.

FIGS. 2-9 show embodiments of an anti-fouling system as used with a buoyancy module 10, which are within the scope of the invention. The invention is in no way restricted to the design of the buoyancy module 10 as shown in FIG. 1 and as explained in the foregoing. The embodiments of the anti-fouling system shown in FIGS. 2-9 are just a number of examples out of numerous possibilities existing within the framework of the invention.

In general, according to the invention, an anti-fouling system is designed for realizing an anti-fouling effect on the exterior surface 16 of the buoyancy module 10. In the context of this description, the term “exterior surface” should be understood such as to include every area of the buoyancy module 10 which is exposed to water when the buoyancy module 10 is in an underwater environment. In a situation without anti-fouling measures being taken, the exterior surface 16 gets covered with a biofouling layer as time passes, which causes the values of the buoyancy and other properties of the buoyancy module 10 to deviate from the initial values as envisaged with the design of the buoyancy module 10. When the invention is applied, such disadvantageous situation is avoided. The fact is that according to the invention, an anti-fouling system is provided which comprises one or more anti-fouling appliances for acting on at least a portion of the exterior surface 16 of the buoyancy module 10 in order to keep at least a portion of the surface 16 free from biofouling. The one or more anti-fouling appliances may have any suitable position with respect to the buoyancy module 10, and may be arranged in the interior of the buoyancy module 10, on the exterior surface 16 of the buoyancy module 10 and/or at an exterior position with respect to the buoyancy module 10. The one or more anti-fouling appliances may particularly comprise one or more anti-fouling energy sources for emitting anti-fouling energy during operation thereof, wherein the one or more anti-fouling appliances may furthermore comprise one or more energy guides for transporting the anti-fouling energy and allowing it to be output at positions which are appropriate for realizing anti-fouling effects on the exterior surface 16 of the buoyancy module 10 in an efficient manner. An exterior structure or add-on may be used with the buoyancy module 10 for carrying one or more energy sources and/or one or more energy guides. In case the one or more energy sources are arranged in, on or close to the buoyancy module 10, it is advantageous to use suitable means for powering the energy sources, which may comprise an electrical cable or the like extending from the energy sources to the surface, wherein the energy sources may be electrically coupled to the electrical cable either in a wired manner or in a wireless manner, or which may comprise devices for locally generating the necessary power, such as so-called Peltier elements which are adapted to generate an electric current on the basis of a temperature difference. In the following, by way of example only, it is assumed that the one or more energy sources come as one or more light sources for emitting ultraviolet light, especially ultraviolet light of the c type, during operation thereof. UVC light is a form of energy which is suitable for killing fouling organisms, rendering such organisms inactive, or rendering such organisms unable to reproduce.

FIG. 2 relates to an option according to which the anti-fouling system comprises at least one tubular ultraviolet lamp 20 arranged in the interior of the buoyancy module 10. In the shown example, the tubular ultraviolet lamp 20 extends from one end of the buoyancy module 10 to another so as to be able to emit ultraviolet light along the entire length/height of the buoyancy module 10. The buoyancy module 10 comprises material which is transparent to ultraviolet light, so as to allow the ultraviolet light emitted by the tubular ultraviolet lamp 20 during operation thereof to reach at least a portion of the exterior surface 16 of the buoyancy module 10. In FIG. 2, for the sake of illustration, the buoyancy module 10 is shown with one transparent half 12, a single tubular ultraviolet lamp 20 being embedded in the transparent material of the half 12. It is evident from the figure that the ultraviolet light emitted by the tubular ultraviolet lamp 20 during operation thereof reaches both the part of the exterior surface 16 which is at the outside of the half 12 and the part of the exterior surface 16 which is at the inside of the half 12 from the interior of the buoyancy module 10, the latter part of the exterior surface 16 being the part of the exterior surface 16 for directly facing an elongated device to be provided with the buoyancy module 10, through the transparent material of the half 12. Hence, the tubular ultraviolet lamp 20 is allowed to act on the entire exterior surface 16 of the half 12 of the buoyancy module 10, so that it is possible to keep the entire exterior surface 16 of the half 12 of the buoyancy module 10 clean from biofouling. In an actual embodiment, it may be practical for both halves 12, 13 of the buoyancy module to be designed so as to accommodate at least one tubular ultraviolet lamp 20 in their interior and to comprise material which is transparent to the ultraviolet light so as to achieve that the entire exterior surface 16 of the buoyancy module 10 can be kept clean from biofouling. On the other hand, it is possible to have an embodiment in which only one half 12, 13 is equipped with at least one lamp 20, and in which the halves 12, 13 are optically coupled in any suitable manner.

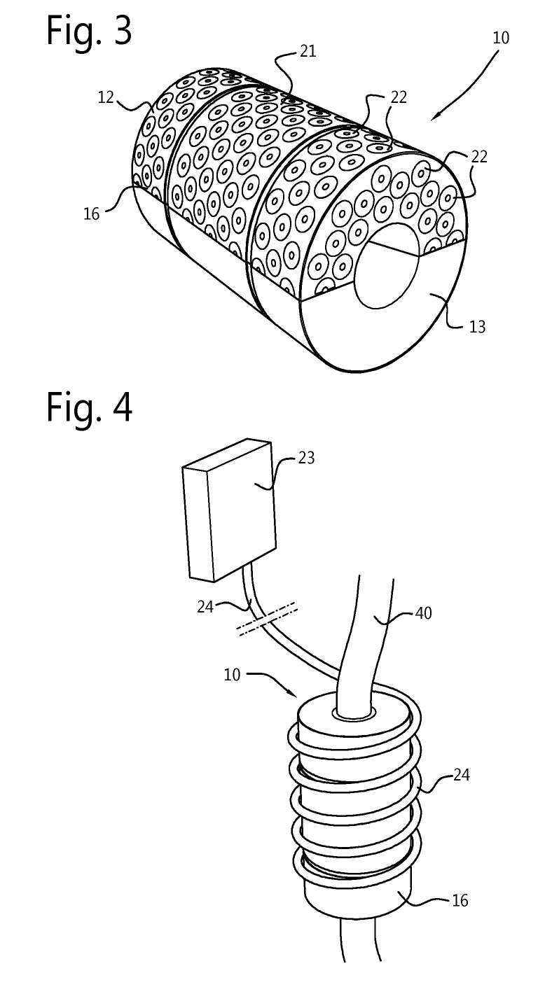

FIG. 3 relates to an option according to which the anti-fouling system comprises an exterior layer 21 of distributed ultraviolet LEDs 22 embedded in the exterior layer 21. The exterior layer 21 comprises material which is transparent to ultraviolet light, so as to allow the ultraviolet light emitted by the LEDs 22 during operation thereof to reach the exterior surface 16 of the buoyancy module 10, which, naturally, is an exterior surface of the exterior layer 21 as well. In FIG. 3, for the sake of illustration, the buoyancy module 10 is shown with an exterior layer 21 which is located at the outside of one half 12 of the buoyancy module 10. It is evident from the figure that the ultraviolet light emitted by the LEDs 22 during operation thereof is very effective in reaching the part of the exterior surface 16 which is at the outside of the half 12 from the interior of the buoyancy module 10, so that an anti-fouling effect can be realized on this part of the exterior surface 16. It goes without saying that in an actual embodiment, it is practical for both halves 12, 13 of the buoyancy module to be designed so as to have an exterior layer 21 of distributed LEDs 22 as described in the foregoing. The entire exterior surface 16 of the buoyancy module 10 can be kept clean from biofouling when the exterior layer 21 is present at both the outside and the inside of both halves 12, 13. An advantage of using the exterior layer 21 is that the layer 21 can simply be added to the buoyancy module 10 at the outside and/or the inside thereof, so that there is no need for a change of the design of the interior of the buoyancy module 10. Furthermore, by applying a plurality of LEDs 22, it is possible to have failure of one or another limited number of LEDs 22 and still have an anti-fouling effect on the exterior surface 16 as desired. Also, LEDs are known for a low consumption of energy. All in all, the embodiment of the anti-fouling system as illustrated in FIG. 3 and as described in the foregoing has many advantageous aspects and is very well suitable to be used in an underwater environment, as it is extremely fail safe and can do without maintenance for that reason.

FIG. 4 relates to an option according to which the anti-fouling system comprises an ultraviolet laser source 23 having an exterior arrangement with respect to the buoyancy module 10 as mounted on an elongated device 40, and furthermore comprises an elongated light guide 24 coupled to the ultraviolet laser source 23, the light guide 24 having a coiled appearance and being wrapped around the buoyancy module 10. In this embodiment of the invention, the ultraviolet laser source 23 can be at a position above the water. The elongated light guide 24 may comprise any suitable type of optical fiber or the like for transporting ultraviolet light with only a minimum loss on the basis of a known principle such as total internal reflection. In the configuration as illustrated in FIG. 4, the elongated light guide 24 is allowed to shed ultraviolet light on the part of the exterior surface 16 as present at the outside of the buoyancy module 10 so as to realize anti-fouling of this part of the exterior surface 16. Like the embodiment comprising the exterior layer 21 of distributed LEDs 22, the embodiment comprising an ultraviolet laser source 23 arranged at a location which is remote from the buoyancy module 10 and a light guide 24 for transporting the ultraviolet light emitted by the ultraviolet laser source 23 during operation thereof to the exterior surface 16 of the buoyancy module 10 can do without maintenance, that is to say, maintenance which would need to be performed in an underwater environment. If the ultraviolet laser source 23 fails, the anti-fouling system can simply be repaired by replacing the well-accessible ultraviolet laser source 23.

With reference to FIG. 4, it is noted that it is also possible to have an ultraviolet light source which is wrapped around the buoyancy module 10. A wrapped configuration of at least one light guide and/or at least one light source can be realized in any suitable manner. Besides the spiral-like structure as illustrated in FIG. 4, it is possible to have sleeve-like structures, for example, which sleeve-like structures may be composed of a strip which is designed to be wrapped around the buoyancy module 10, or may comprise a sleeve-like piece which can be put to an opened condition and a closed condition in any suitable fashion such as by means of a zipper-like closure. The sleeve-like piece may comprise a layer of massive material or may have a net-like structure, for example.

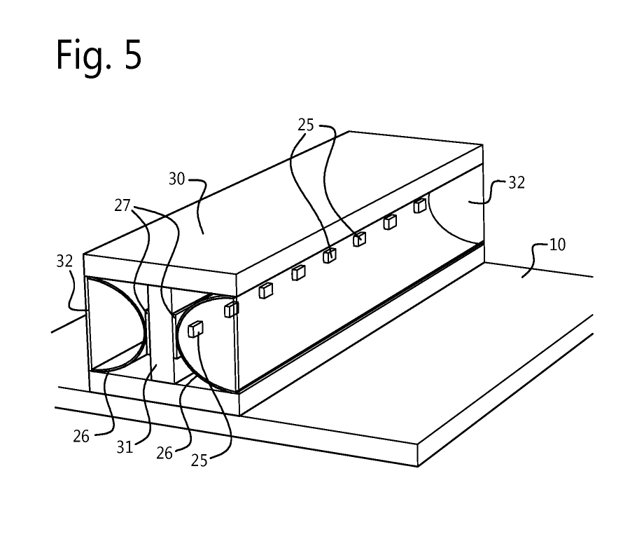

FIG. 5 relates to an option according to which the anti-fouling system comprises a structure for supporting a plurality of light sources and associated components, which is furthermore also suitable for providing protection of the light sources and the components. By way of example of this option, FIG. 5 shows an I bar 30 for use with the buoyancy module 10, the I bar 30 accommodating ultraviolet light sources 25 and reflectors 26. The I bar 30 can be arranged at any suitable position outside of the buoyancy module 10, and may for example be curved such as to follow the curved exterior surface 16 of the buoyancy module 10 at the outside of the buoyancy module 10 in a spiraling fashion. In the shown example, the light sources 25 comprise LEDs which are arranged on a printed circuit board 27 extending along the central beam 31 of the I bar 30.

A combination of light sources 25, reflectors 26 and a printed circuit board 27 may be provided at only one side of the central beam 31, but it is also possible to have such combination at both sides of the central beam 31 if appropriate in a given situation, as is the case with the shown example. The I bar 30 could actually do without the reflectors 26, but the application of the reflectors 26 results in the possibility of having a safe and protected position of the light sources 25 in the I bar 30 and still achieving high effectiveness of the anti-fouling process to be performed by means of the light sources 25, wherein the reflectors 26 serve for shaping light rays. In the shown example, the reflectors 26 have a curved shape and are provided with holes at positions corresponding to positions of the light sources 25. For optimal protection of the various components arranged on the I bar 30, it is preferred to have optical exit windows 32 at both sides of the central beam 31 for covering the spaces as present in the I bar 30 and thereby realizing a closed configuration for accommodating the components. Spaces between the reflectors 26 and the optical exit windows 32, as present at both sides of the I bar 30 in the shown example, may be filled with a solid such as silicone or with a fluid such as a liquid, air or compressed gas.

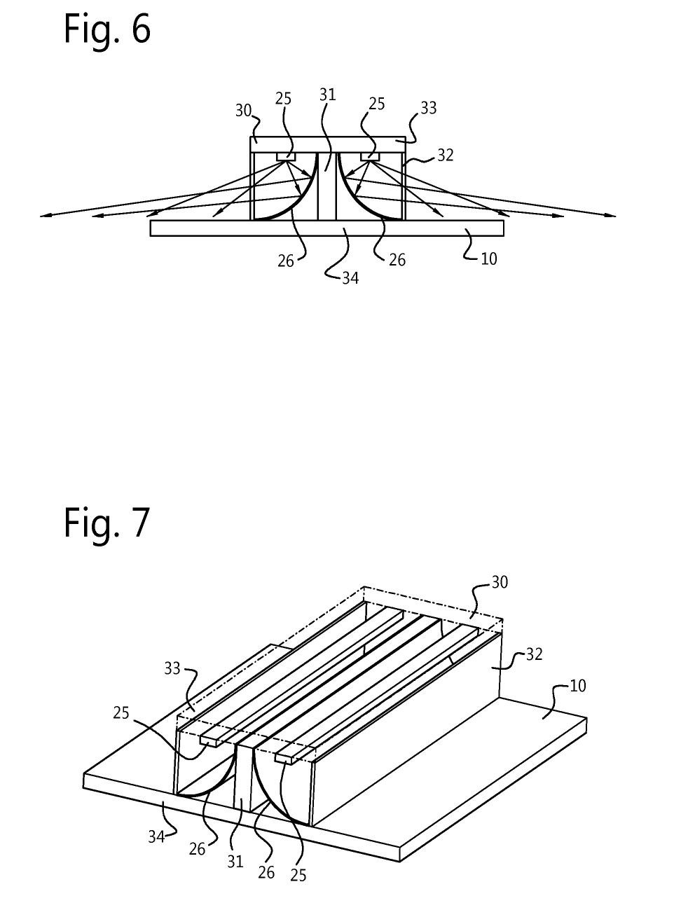

FIGS. 6 and 7 illustrate one of the possible alternative embodiments of the I bar 30. In this alternative embodiment, the light sources 25 are arranged on one of the transverse beams 33, 34 of the I bar 30, whereas the curved reflectors 26 are arranged at a position which is a position behind the light sources 25, covering both the central beam 31 and the transverse beam 34 which is opposite to the transverse beam 33 supporting the light sources 25. In respect of the transverse beam 34 which is opposite to the transverse beam 33 supporting the light sources 25, it is noted that this transverse beam 34 may be arranged such as to be integrated with the buoyancy module 10, as diagrammatically shown in FIG. 7. In FIG. 6, the way in which light shines from the I bar 30 during operation of the light sources 25, either shining directly from the light sources 25 or shining indirectly from the light sources 25 via the reflectors 26, is indicated by a number of arrows.

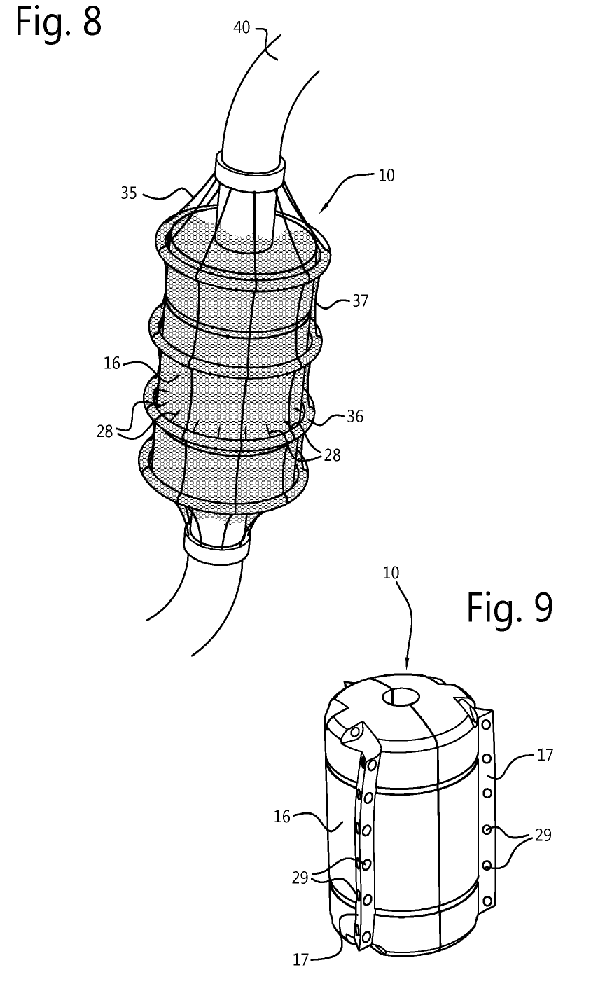

FIG. 8 relates to an option according to which the anti-fouling system comprises at least one ultraviolet light source which is suspended at a certain distance from the buoyancy module 10. In the shown example, a structure 35 encompassing the buoyancy module 10 is provided, which is suitable for accommodating a plurality of light sources 28, particularly in or on at least one ring 36 which may be part of the structure 35, wherein the structure 35 may comprise a sleeve-like net 37 in which the one or more rings 36 are incorporated, as illustrated in FIG. 8. The at least one ring 36 may for example comprise a light hose, or an I bar 30 as shown in FIGS. 5-7 bent to a ring-shaped configuration. The structure 35 can be connected to an elongated device 40 on which the buoyancy module 10 is mounted, which does not alter the fact that it is also possible for the structure 35 to be designed for direct connection to the buoyancy module 10. Suitable spacers (not shown) may be used for keeping the at least one ring 36 in a more or less concentric positioning with the buoyancy module 10, in order to ensure effective anti-fouling action on the exterior surface 16 of the buoyancy module 10 along the entire outer periphery thereof. The at least one ring 36 may be equipped with any suitable locking mechanism, such as a snap lock.

FIG. 9 relates to an option according to which the anti-fouling system makes use of the fact that it is known for buoyancy modules 10 to be equipped with drag-reducing baffles 17. In particular, FIG. 9 serves to illustrate a possibility of having light sources 29 arranged on the baffles 17, wherein the light sources 29 may be integrated in the baffles 17 and/or may be arranged on the baffles 17 as add-ons. In any case, the configuration of the light sources 29 in/on the baffles 17 may be designed in such a way that the light sources 29 are mechanically protected by the baffles 17. In respect of the optional baffles 17 of the buoyancy module 10, it is furthermore noted that the baffles 17 may be used as spacers of a structure for supporting at least one light source and/or at least one light guide, such as the structure 35 shown in FIG. 8, and also that the baffles 17 may be equipped with a power source or a power generator for powering a light source and/or at least one light guide for use with the buoyancy module 10, which does not alter the fact that such power source or power generator may be arranged at any suitable position with respect to the buoyancy module 10 within the framework of the invention.

It will be clear to a person skilled in the art that the scope of the invention is not limited to the examples discussed in the foregoing, but that several amendments and modifications thereof are possible without deviating from the scope of the invention as defined in the attached claims. It is intended that the invention be construed as including all such amendments and modifications insofar they come within the scope of the claims or the equivalents thereof. While the invention has been illustrated and described in detail in the figures and the description, such illustration and description are to be considered illustrative or exemplary only, and not restrictive. The invention is not limited to the disclosed embodiments. The drawings are schematic, wherein details that are not required for understanding the invention may have been omitted, and not necessarily to scale. Variations to the disclosed embodiments can be understood and effected by a person skilled in the art in practicing the claimed invention, from a study of the figures, the description and the attached claims. In the claims, the word “comprising” does not exclude other steps or elements, and the indefinite article “a” or “an” does not exclude a plurality. The term “comprise” as used in this text will be understood by a person skilled in the art as covering the term “consist of”. Hence, the term “comprise” may in respect of an embodiment mean “consist of”, but may in another embodiment mean “contain/include at least the defined species and optionally one or more other species”. Any reference signs in the claims should not be construed as limiting the scope of the invention.

Elements and aspects discussed for or in relation with a particular embodiment may be suitably combined with elements and aspects of other embodiments, unless explicitly stated otherwise. Thus, the mere fact that certain measures are recited in mutually different dependent claims does not indicate that a combination of these measures cannot be used to advantage.

The invention can be summarized as follows. In an assembly of a buoyancy module 10 and an anti-fouling system, the buoyancy module 10 is adapted to floatingly support a functional device 40 in an underwater environment. In particular, the anti-fouling system comprises at least one anti-fouling appliance 20, 21, 22, 23, 24, 25, 28, 29 for performing an anti-fouling action on at least a portion of the exterior surface 16 of the buoyancy module 10, wherein the anti-fouling appliance 20, 21, 22, 23, 24, 25, 28, 29 has an exterior arrangement with respect to the buoyancy module 10 while being mechanically coupled to the buoyancy module 10 and/or being adapted for mechanical coupling to a functional device 40, and/or is arranged on the exterior surface 16 of the buoyancy module 10, and/or is arranged on the exterior surface 16 of the buoyancy module 10, and wherein anti-fouling energy may be supplied to the surface 16 in at least one of a direct and an indirect fashion. In a practical embodiment, the anti-fouling appliance 20, 21, 22, 23, 24, 25, 28, 29 comprises an ultraviolet light source 20, 21, 22, 23, 25, 28, 29 and possibly also a light guide 24 coupled to the ultraviolet light source 20, 21, 22, 23, 25, 28, 29.

1. An assembly of a buoyancy module and an anti-fouling system, the buoyancy module being adapted to floatingly support a functional device in an underwater environment, and the anti-fouling system comprising at least one anti-fouling appliance for performing an anti-fouling action on at least a portion of the exterior surface of the buoyancy module, wherein the anti-fouling appliance
has an exterior arrangement with respect to the buoyancy module, in which at least a portion of the anti-fouling appliance is supported on the buoyancy module and/or is adapted to be supported on a functional device, and/or
is arranged on the exterior surface of the buoyancy module, and/or
is arranged in the interior of the buoyancy module.

2. The assembly according to claim 1, wherein the anti-fouling appliance is adapted to emit anti-fouling energy during operation thereof, wherein the anti-fouling appliance is at least partially arranged in the interior of the buoyancy module, and wherein the anti-fouling system comprises at least one portion of the buoyancy module which is transparent to the anti-fouling energy and includes at least a portion of the exterior surface of the buoyancy module.

3. The assembly according to claim 2, wherein the portion of the buoyancy module which is transparent to the anti-fouling energy comprises an exterior layer of the buoyancy module, and wherein optionally the anti-fouling system comprises a plurality of anti-fouling energy sources for emitting anti-fouling energy during operation thereof, the energy sources being arranged in a grid or mesh which is incorporated in the layer.

4. The assembly according to claim 1, wherein at least a portion of the anti-fouling appliance has an elongated appearance and is arranged with respect to the buoyancy module in a spiral-like fashion.

5. The assembly according to claim 1, wherein the anti-fouling system comprises a structure extending around or through the buoyancy module and holding at least a portion of the anti-fouling appliance at a position which is a position at a distance from the buoyancy module.

6. The assembly according to claim 5, wherein the structure has a sleeve-like appearance, and wherein optionally the structure comprises at least one ring, at least a portion of the anti-fouling appliance being incorporated in the at least one ring.

7. The assembly according to claim 5, wherein the structure has an elongated shape and is arranged with respect to the buoyancy module in a spiral-like fashion.

8. The assembly according to claim 5, wherein the structure is adapted to provide mechanical protection of at least a portion of the anti-fouling appliance.

9. The assembly according to claim 1, wherein the anti-fouling appliance is adapted to emit anti-fouling energy during operation thereof, and wherein the anti-fouling system comprises reflecting means for directing the anti-fouling energy towards at least a portion of the exterior surface of the buoyancy module.

10. The assembly according to claim 1, wherein the buoyancy module is equipped with outwardly extending drag reducing baffles, and wherein the anti-fouling system comprises anti-fouling energy sources for emitting anti-fouling energy during operation thereof, the anti-fouling energy sources being arranged on the baffles.

11. The assembly according to claim 1, wherein the anti-fouling system comprises at least one energy source for emitting anti-fouling energy during operation thereof, the anti-fouling energy being ultraviolet light.

12. An anti-fouling system comprising at least one anti-fouling appliance for performing an anti-fouling action on at least a portion of the exterior surface of a buoyancy module, intended for use in the assembly according to claim 1.

13. A buoyancy module for mounting on a functional device for floatingly supporting the functional device in an underwater environment, intended for use in the assembly according to claim 1.

14. An assembly of a functional device and at least one buoyancy module according to claim 13 arranged on the functional device, the functional device optionally being a marine riser module.

15. A marine system, comprising a marine device for retrieving matter from the (sub) sea bed and at least one assembly according to claim 14, the marine device being in communication with the (sub) sea bed through the functional device of the assembly.
